(19) United States
(12) Patent Application Publication
(10) Pub. No.: US 2011/0226085 A1
(43) Pub. Date: Sep. 22, 2011

(54) CONTROL CABLE

(76) Inventor: Takaaki Hayashida, Nagoya-shi (JP)

(21) Appl. No.: 13/049,820

(22) Filed: Mar. 16, 2011

(30) Foreign Application Priority Data
Mar. 17, 2010 (JP) 2010-061273

(51) Int. Cl. F16C 1/26; F16C 1/20

(52) U.S. Cl. 74/502.5

(57) ABSTRACT

A control cable (1) suitable for automotive applications comprises an outer cable (2) and an inner cable (3). The outer cable (2) includes a tubular liner (2a). The inner cable (3) is slidably disposed within an inner hollow of the liner (2a). The liner (2a) comprises a resin composition including polybutylene terephthalate, polyethylene, and acrylonitrile styrene.

### CROSS-REFERENCE TO RELATED APPLICATION

This application claims priority to Japanese Patent Application No. 2010-61273, filed on Mar. 17, 2010, the contents of which are hereby incorporated by reference into the present application.

### TECHNICAL FIELD

The present application relates to a control cable for automotive applications used in a vehicle (e.g., an automobile, a motorcycle, or an industrial vehicle such as a forklift).

### DESCRIPTION OF RELATED ART

A control cable for automotive applications comprises an outer cable and an inner cable disposed within a hollow interior of the outer cable. When an operator operates the inner cable, the inner cable slides with respect to the outer cable. A large sliding resistance between the inner cable and the outer cable blunts operation feel. Therefore, in order to reduce the sliding resistance between the inner cable and the outer cable, a control cable for automotive applications is being developed in which a resin liner is provided at an innermost layer of the outer cable.

In a conventional control cable for automotive applications, a liner at the innermost layer of the outer cable is formed by a resin material such as polyethylene (PE), polytetrafluoroethylene (PTFE), and polybutylene terephthalate (PBT). A liner formed of polyethylene (PE) is inexpensive and superior in slidability but is problematically low in heat resistance. A liner formed of polytetrafluoroethylene (PTFE) is superior in both slidability and heat resistance but is problematically expensive. In addition, a liner formed of polybutylene terephthalate (PBT) is inexpensive and superior in heat resistance but is problematically inferior in slidability. Therefore, when both heat resistance and slidability are required (e.g., in a case of a control cable to be used inside an engine room), a liner formed of polytetrafluoroethylene (PTFE) must be used. As a result, control cables are costly.

### BRIEF SUMMARY

It is an object of the present teachings to provide a control cable for an automotive application having a liner superior in both slidability and heat resistance without using polytetrafluoroethylene.

In one aspect of the present teachings, a control cable for an automotive application comprises an outer cable and an inner cable. The outer cable includes a tubular liner. The inner cable is slidably disposed within an inner hollow of the liner. The liner comprises a resin composition including polybutylene terephthalate, polyethylene, and acrylonitrile styrene.

In this control cable, the liner of an innermost layer of the outer cable is formed of the resin composition including polybutylene terephthalate, polyethylene, and acrylonitrile styrene. Although polybutylene terephthalate and polyethylene have low compatibility, acrylonitrile styrene enables polybutylene terephthalate and polyethylene to be combined without causing segregation. Since the liner is formed of the resin composition including polybutylene terephthalate and polyethylene, both the slidability and heat resistance can be improved.

These aspects and features may be utilized singularly or, in combination, in order to make improved control cables. In addition, other objects, features and advantages of the present teachings will be readily understood after reading the following detailed description together with the accompanying drawings and claims. Of course, the additional features and aspects disclosed herein also may be utilized singularly or, in combination with the above-described aspect and features.

### BRIEF DESCRIPTION OF DRAWINGS

FIG. 1 is a partially cutaway perspective view for explaining a control cable according to a representative embodiment of the present teachings.

FIG. 2 is a cross section taken along II-II in FIG. 1

FIG. 3 is a histogram illustrating a measurement result of load transmitting efficiency.

FIG. 4 is a graph illustrating a relationship between numbers of operations and load transmitting efficiency.

### DETAILED DESCRIPTION

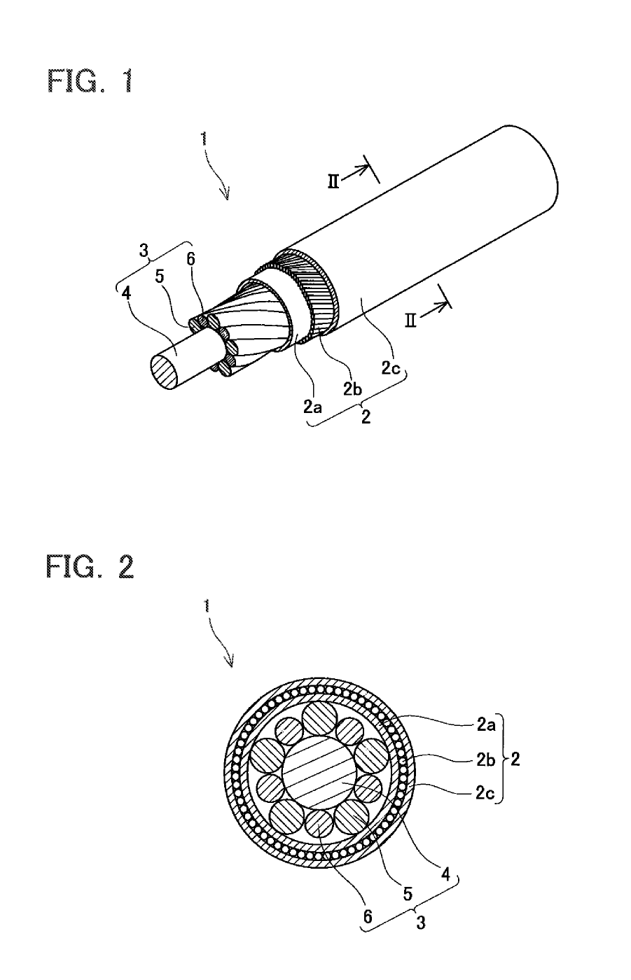

A control cable according to a representative embodiment of the present teachings will now be described. As shown in FIGS. 1 and 2, a control cable 1 comprises an inner cable 3 and an outer cable 2 into which the inner cable 3 is slidably inserted.

The inner cable 3 comprises a core wire 4, a plurality of main auxiliary wires 5, and a plurality of sub auxiliary wires 6. The core wire 4 is a single metal wire. For example, a hard steel wire, a stainless steel wire, an oil-tempered wire (e.g., SWO-A, SWO-B, SWOSC-V), and a bluing wire may be used as a material of the core wire 4. For purposes of rust-proofing, zinc plating may be applied on a surface of the core wire 4. The plurality of main auxiliary wires 5 are spirally wound around the core wire 4. Similarly, the plurality of sub auxiliary wires 6 are spirally wound around the core wire 4 and interposed between adjacent main auxiliary wires 5. In this embodiment, as shown in FIG. 2, five main auxiliary wires 5 and five sub auxiliary wires 6 are wound around the core wire 4. However, numbers of the main auxiliary wires 5 and the sub auxiliary wires 6 need not be five, and an arbitrary number (e.g., seven) may be adopted. From a perspective of increasing load transmitting efficiency, the numbers of the main auxiliary wires 5 and the sub auxiliary wires 6 are favorably set to odd numbers. A same material as the core wire 4 may be used for the main auxiliary wires 5 and the sub auxiliary wires 6. In addition, zinc plating may also be applied to surfaces of the main auxiliary wires 5 and the sub auxiliary wires 6.

Moreover, in addition to the configuration described above, various known configurations may be adopted for the inner cable. For example, a single wire structure comprising a single metal wire or a twisted wire structure without the core wire (e.g., a twisted wire in which a plurality of metal wires is twisted together) may be adopted.

The outer cable 2 may have a trilaminar structure that is configured such that an innermost layer is a resin liner 2; an intermediate layer is a strand 2b constituted by a plurality of metal wires, and an outermost layer is an outer coat 2c. The liner 2a is formed in a tubular shape by a resin composition to be described in detail later. The strand 2b may be configured such that the plurality of metal wires is tightly twisted together in a helical fashion around the liner 2a. The outer coat 2c that covers an outer circumference of the strand 2b may be formed by polypropylene, polyethylene, polyamide, or the like.

The resin composition that forms the liner 2a includes polybutylene terephthalate (PBT), polyethylene (PE), and acrylonitrile styrene (AS). Polybutylene terephthalate (PBT) may be synthesized by a polycondensation of terephthalic acid (TPA) or dimethyl terephthalate (DMT) and 1,4-butanediol. For example, 1401X06 manufactured by Toray Industries, Inc. may be used as polybutylene terephthalate (PBT). Polyethylene (PE) is a polymer having an ethylene-polymerized structure. High-density polyethylene (HDPE), low-density polyethylene (LDPE), ultrahigh molecular weight polyethylene (UHMW-PE), and the like may be used as a material of the liner 2a. Favorably, low-density polyethylene (LDPE) is used. Acrylonitrile styrene (AS) is a copolymer of styrene and acrylonitrile. Moreover, when generating the resin composition to form the liner 2a, a material may be used in which polyethylene (PE) and acrylonitrile styrene (AS) have been copolymerized in advance. For example, MODIPER® A1401 manufactured by NOF CORPORATION is known as such a material.

In the present embodiment, by adding polyethylene (PE) having superior slidability to polybutylene terephthalate (PBT) having superior heat resistance, both the slidability and heat resistance can be secured. However, polybutylene terephthalate (PBT) and polyethylene (PE) have low compatibility. Therefore, a mere addition of polyethylene (PE) to polybutylene terephthalate (PBT) cannot inhibit polyethylene (PE) from segregating in polybutylene terephthalate (PBT), and the slidability and heat resistance cannot be achieved concurrently. In consideration thereof, in the present embodiment, acrylonitrile styrene (AS) is further added. As one of specific adding methods, for example, a copolymer is formed by copolymerizing polyethylene (PE) and acrylonitrile styrene (AS) at a predetermined composition ratio, and then the copolymer is added to polybutylene terephthalate. A weight ratio of polyethylene (PE) and acrylonitrile styrene (AS) may be set to, for example, 50/50 to 70/30. In addition, the copolymer of polyethylene (PE) and acrylonitrile styrene (AS) may be added to polybutylene terephthalate (PBT) at, for example, 5 to 20% by weight.

Moreover, a method of adding polyethylene (PE) and acrylonitrile styrene (AS) to polybutylene terephthalate (PBT), a weight ratio of polyethylene (PE) and acrylonitrile styrene (AS), an added amount of polyethylene (PE) and acrylonitrile styrene (AS), and the like are not limited to the above and may be modified as appropriate.

In addition, an ordinary additive such as an antioxidant, a thermal stabilizer, a lubricant, a nucleating agent, an ultraviolet ray protective agent, a colorant, and a flame retardant, as well as a small amount of another polymer, may be added to the resin composition that forms the liner 2a within limits that do not affect the heat resistance and slidability. Furthermore, the resin composition described above may be made into the tubular liner 2a using a known method.

### Example 1

While a control cable according to an example of the present teachings will be described below, it is to be understood that the present teachings is not limited thereto.

First, the slidability of the resin composition used to form the liner 2a according to the present teachings was evaluated. Specifically, the resin composition was generated by adding the copolymer in which polyethylene (PE) and acrylonitrile styrene (AS) are copolymerized at the weight ratio of 50/50 to polybutylene terephthalate (PBT) at 10% by weight. 1401X06 manufactured by Toray Industries, Inc. was used as polybutylene terephthalate (PBT), and MODIPER®(A1401 manufactured by NOF CORPORATION was used as the copolymer of polyethylene (PE) and acrylonitrile styrene (AS). The generated resin composition was molded into a plate shape by extrusion molding. In the molded plate-shaped resin composition, polyethylene (PE) was found not segregated but scattered in polybutylene terephthalate (PBT). As comparative examples, a resin composition constituted by polyethylene (PE) was molded into a plate shape, a resin composition constituted by polytetrafluoroethylene (PTFE) was molded into a plate shape, and a resin composition constituted by polybutylene terephthalate (PBT) was molded into a plate shape. A coefficient of friction was measured for each of the molded plate-shaped resin compositions. A friction and wear tester was used for measuring the coefficients of friction of the resin compositions against a hard steel wire (corresponding to the inner cable (length=20 mm)) whose surface was subjected to zinc plating. Measurement results are illustrated in Table 1. As is apparent from Table 1, the resin composition according to the present example had a low coefficient of friction.

TABLE 1

| | Coefficient of | |
|---|---|---|
| Material | friction μ | Upper temperature limit |
| PBT + PE + AS (example) | 0.045 | 140° C. |
| PTFE (comparative example) | 0.035 | 180° C. |
| PE (comparative example) | 0.044 | 80° C. |
| PBT (comparative example) | 0.058 | 140° C. |

Next, the liner 2a was manufactured using a resin composition (i.e., copolymer of polyethylene (PE) and acrylonitrile styrene (AS) added at 10% by weight) having the same composition as the resin composition on which slidability was measured, and the liner 2a was used to manufacture the control cable 1. Specifically, first, the resin composition described above was formed into a tubular shape by extrusion molding to manufacture the liner 2a. The manufactured liner 2a had an inner diameter of 2.45 mm and a thickness of 0.575 mm. Next, the strand 2b and the outer coat 2c were formed on the outer circumference of the manufactured liner 2a to manufacture the outer cable 2. In addition, as illustrated in FIG. 2, the inner cable 3 was manufactured by spirally winding the main auxiliary wires 5 and the sub auxiliary wires 6 (five respectively) around the core wire 4. Zinc plating was applied to the surfaces of the core wire 4, the main auxiliary wires 5, and the sub auxiliary wires 6. An outer diameter of the inner cable was set to 2.35 mm. The control cable 1 was manufactured by inserting the manufactured inner cable 3 into the manufactured outer cable 2. Moreover, a silicone grease was enclosed between the outer cable 2 and the inner cable 3. Next, the heat resistance of the manufactured control cable 1 was measured. For the measurement of heat resistance, the manufactured control cable 1 was actually arranged (in other words, routing as would take place in an actual vehicle was performed), and an operation endurance test and a fluctuation test were performed while varying atmosphere temperatures. An upper limit of a temperature where no functional problems are created by the control cable 1 was acquired as an upper temperature limit. As comparative examples, in the same manner as in the measurement of the slidability described earlier, the upper temperature limit was each measured for a control cable having a liner constituted by polyethylene (PE), a control cable having a liner constituted by polytetrafluoroethylene (PTFE), and a control cable having a liner constituted by polybutylene terephthalate (PBT). Measurement results are illustrated in Table 1. As is apparent from Table 1, the control cable 1 according to the present example had a high upper temperature limit.

Next, an influence of an added amount of the copolymer of polyethylene (PE) and acrylonitrile styrene (AS) was evaluated. Specifically, the control cable 1 was manufactured by varying the added amount of the copolymer (weight ratio 50/50) of polyethylene (PE) and acrylonitrile styrene (AS) with respect to polybutylene terephthalate from 5% by weight (first example) to 10% by weight (second example), and to 20% by weight (third example). Other specifications of the control cable 1 were set the same as when heat resistance was measured as described above. As a comparative example, a control cable comprising a liner formed of polytetrafluoroethylene (PTFE) was manufactured. A configuration of the control cable according to the comparative example other than the liner was set the same as the control cables according to the first to third examples.

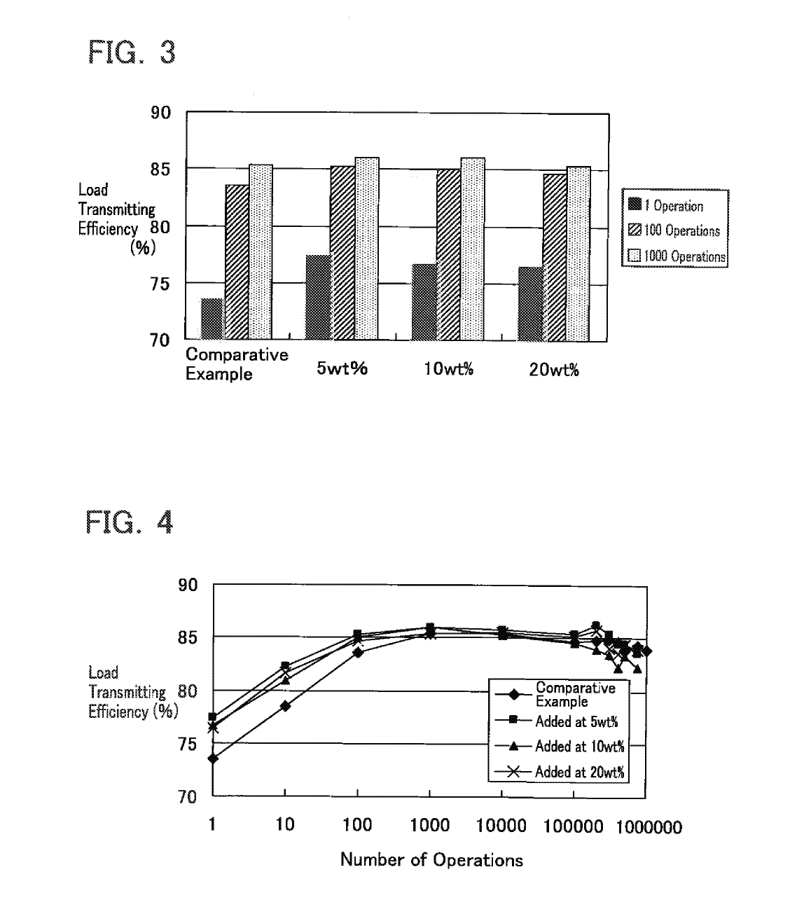

The control cable 1 manufactured as described above was arranged in a bent state. A weight was mounted to one end of the inner cable and another end of the inner cable was moved so as to advance and retreat at a stroke of 100 mm and at a speed of 30 times/minute, and a load necessary for operating the other end of the inner cable was measured. A load transmitting efficiency (in other words, weight/measured load) was calculated based on the measured load and the weight mounted to the one end of the inner cable. It was found that the smaller the sliding resistance between the inner cable 3 and the outer cable 2, the smaller the difference between the weight and the measured load, and the higher the load transmitting efficiency. On the other hand, the greater the sliding resistance between the inner cable 3 and the outer cable 2, the greater the difference between the weight and the measured load, and the lower the load transmitting efficiency. Therefore, the slidability of the liner 2a and the inner cable 3 can be evaluated according to load transmitting efficiency. Measurement results are illustrated in FIGS. 3 and 4. As is apparent from FIGS. 3 and 4, for all of the control cables according to the first to third examples, a load transmitting efficiency more superior than the comparative example was obtained when number of operations ranged from 1 to 1000, and a load transmitting efficiency equal to the comparative example was obtained when the number of operations exceeded 1000.

As described in detail above, even without using expensive polytetrafluoroethylene, the control cable 1 according to the present example is able to acquire similar slidability and heat resistance as a liner using polytetrafluoroethylene.

The preferred embodiments of the present teachings have been described above, the explanation was given using, as an example, the present teachings is not limited to this type of configuration.

Finally, although the preferred representative embodiments have been described in detail, the present embodiments are for illustrative purpose only and not restrictive. It is to be understood that various changes and modifications may be made without departing from the spirit or scope of the appended claims. In addition, the additional features and aspects disclosed herein also may be utilized singularly or in combination with the above aspects and features.

What is claimed is:

1. A control cable for an automotive application comprising:
an outer cable including a tubular liner, and
an inner cable slidably disposed within an inner hollow of the liner,
wherein the liner comprises a resin composition including polybutylene terephthalate, polyethylene, and acrylonitrile styrene.

2. The control cable as in claim 1, wherein the liner is made of polybutylene terephthalate resin composition, in which a copolymer including polyethylene and acrylonitrile styrene is added, and a weight ratio of the polyethylene and the acrylonitrile styrene in the copolymer is 50/50 to 70/30.

3. The control cable as in claim 2, wherein the weight ratio of the polyethylene and the acrylonitrile styrene in the copolymer is 50/50.

4. The control cable as in claim 3, wherein the copolymer is added to the polybutylene terephthalate resin composition at 5 to 20% by weight.

5. The control cable as in claim 4, wherein the outer cable further comprises a plurality of metal wires twisted together around the liner, and an outer coat that covers an outer circumference of the plurality of metal wires.

6. The control cable as in claim 5, wherein a surface of the inner cable is plated by Zn.

7. The control cable as in claim 6, wherein the inner cable comprises a core wire, a plurality of main auxiliary wires, and a plurality of sub auxiliary wires,
the plurality of main auxiliary wires are spirally wound around the core wire, and
the plurality of sub auxiliary wires are spirally wound around the core wire and interposed between adjacent main auxiliary wires.

8. The control cable as in claim 7, wherein a surface of the core wire is plated by Zn, each surface of the main auxiliary wires is plated by Zn, and each surface of the sub auxiliary wires is plated by Zn.

9. The control cable as in claim 1, wherein
the liner is made of polybutylene terephthalate resin composition, in which a copolymer including polyethylene and acrylonitrile styrene is added,
a weight ratio of the polyethylene and the acrylonitrile styrene in the copolymer is 50/50 to 70/30, and
the copolymer is added to the polybutylene terephthalate resin composition at 5 to 20% by weight.

10. The control cable as in claim 9, wherein a surface of the inner cable is plated by Zn.
